(19) United States
(12) Patent Application Publication
(10) Pub. No.: US 2021/0394492 A1
(43) Pub. Date: Dec. 23, 2021

(54) POLYMER INTERLAYERS HAVING REDUCED COLOR

(71) Applicant: Solutia Inc., St. Louis, MO (US)

(72) Inventors: Bert Jozef Campo, Melle (BE); Howard D. Booth, JR., Westfield, MA (US)

(73) Assignee: Solutia Inc., St. Louis, MO (US)

(21) Appl. No.: 17/309,213

(22) PCT Filed: Dec. 10, 2019
(86) PCT No.: PCT/US2019/065374

§ 371 Date: May 7, 2021

Related U.S. Application Data
(60) Provisional application No. 62/777,826, filed on Dec. 11, 2018.

(51) Int. Cl. B32B 17/10

(52) U.S. Cl. CPC B32B 17/10651; B32B 17/10036; B32B 17/10605; B32B 2250/40; B32B 2307/4026; B32B 2307/732; B32B 2250/03; B32B 17/10761

(57) ABSTRACT

Polymer interlayers that have low color for multiple layer panels are disclosed. The use of polymer interlayers having low color provide multiple layer panels with low color and lower yellowness index.

### BACKGROUND OF THE INVENTION

### 1. Field of the Invention

This disclosure is related to the field of polymer interlayers for multiple layer panels and multiple layer panels having at least one polymer interlayer sheet. Specifically, this disclosure is related to the field of polymer interlayers having low color and multiple layer panels comprising the polymer interlayers that have low color, particularly low yellow color.

### 2. Description of Related Art

Multiple layer panels are generally panels comprised of two sheets of a substrate (such as, but not limited to, glass, polyester, polyacrylate, or polycarbonate) with one or more polymer interlayers sandwiched therebetween. The laminated multiple layer glass panels are commonly utilized in architectural window applications and in the windows of motor vehicles and airplanes. These applications are commonly referred to as laminated safety glass. The main function of the interlayer in the laminated safety glass is to absorb energy resulting from impact or force applied to the glass, to keep the layers of glass bonded even when the force is applied and the glass is broken, and to prevent the glass from breaking up into sharp pieces. Additionally, the interlayer may, among other things, give the glass a much higher sound insulation rating, reduce UV and/or IR light transmission, or enhance the aesthetic appeal of the associated window. The interlayer may be a single layer, a combination of two or more single layers, a multilayer that has been coextruded, a combination of at least one single layer and at least one multilayer, or a combination of multilayer sheets.

Laminated safety glass, or multiple layer glass panels, is used in many different applications hi the transportation industry, including automotive, railroad, and aviation vehicles. Polymer interlayers used in laminated safety glass have also been used in architectural or building applications as, for example, panels for windows in buildings or stadiums, balustrades, decorative panels (such as in offices), and the like. Such applications allow additional creativity by incorporating color and other decorative features into a design.

Interlayers for windows, windshields and other multiple layer glass panel applications are generally produced by mixing a polymer resin (or resins) such as poly(vinyl butyral) with one or more plasticizers and other additives and melt processing the mix into a sheet by any applicable process or method known to one of skill in the art, including, but not limited to, extrusion. For multiple layer interlayers comprising two or more layers, the layers may be combined by processes such as co-extrusion and lamination. Other additional ingredients may optionally be added for various other purposes. After the interlayer sheet is formed, it is typically collected and rolled for transportation and storage and for later use in the multiple layer glass panel, as discussed below.

In the process of making the PVB interlayers, organic compounds may be added to the formulations along with the resins and plasticizers (and any other additives), and these organic compounds often have a certain color. During the extrusion of the interlayer, additional color may be added (or the process temperatures may cause some additional color), and this sometimes results in an interlayer that has a slight yellow color.

In the past, the addition of additives such as stabilizers and optical brighteners have been added to the formulations in an attempt to reduce the yellowness or yellow color. Additionally, attempts have been made to limit the contributions of the individual components to the yellowness and by modifying the manufacturing process, but it is not practical to eliminate all yellowness or yellow color in this way. Current commercially available PVB interlayers typically have a yellowness index (YI) of at least about 2 (YI as measured and calculated according to ASTM D1348 and E313 on a nominal thickness of 6.3 mm of PVB sheet, as further described below), and the interlayers with the lowest yellow color (that is, the color closest to being color neutral), measured in the CIELab color space, has L* values of greater than about 95, a* values of less than −1.0 and b* values of greater than 2.0 or greater than 2.5 (as measured by ASTM methods E313 for YI and E308 for color).

Contemplated polymer interlayers include, but are not limited to, poly(vinyl)acetal resins such as poly(vinyl butyral) (PVB). Multilayer laminates can include multiple layer glass panels and multilayer polymer films. In certain embodiments, the multiple polymer films in the multilayer laminates may be laminated together to provide a multilayer film or interlayer. In certain embodiments, these polymer films may have coatings, such as metal, silicone or other applicable coatings known to those of ordinary skill in the art. The individual polymer films which comprise the multilayer polymer films may be laminated together using an adhesive as known to those of ordinary skill in the art.

The following offers a simplified general description of the manner in which multiple layer glass panels are generally produced in combination with the interlayers. First, at least one polymer interlayer sheet (single or multilayer) is placed between two substrates, such as glass panels, and any excess interlayer is trimmed from the edges, creating an assembly. It is not uncommon, particularly in architectural and/or building applications such as windows in buildings, interior or exterior panels, balustrades, and the like, for multiple polymer interlayer sheets or a polymer interlayer sheet with multiple layers (or a combination of both) to be placed within the two substrates creating a multiple layer glass panel with multiple polymer interlayers. Then, air is removed from the assembly by an applicable process or method known to one of skill in the art; e.g., through nip rollers, vacuum bag or another deairing mechanism. Additionally, the interlayer is partially press-bonded to the substrates by any method known to one of ordinary skill in the art. In a last step, in order to form a final unitary structure, this preliminary bonding is rendered more permanent by, for example, a high temperature and pressure lamination process known to one of ordinary skill in the art such as, but not limited to, autoclaving, or by other processes known to one of ordinary skill in the art.

One of the problems in the manufacture of multilayer laminate glass panels is the presence of various optical defects and/or undesirable color in the final unitary structure or laminate, such as the window or panel. The multiple layer glass panels need to be free of optical defects and have consistent color or tone. Additionally, the multiple layer glass panels need to be aesthetically pleasing, that is, the glass panels cannot have undesirable manufacturing defects. It is important to maintain the high optical standards when adding new features and functionality to the glass panels.

Good optical quality and color tone is particularly important where the multiple layer glass panels are those used in applications which require higher levels of optical or visual quality, such as windows. In an attempt to improve the multiple layer glass panels used in windows and other glazing applications, and particularly in an attempt to make them more aesthetically pleasing to the consumer, new colors and features are constantly being developed. There is a need for improved interlayers for use in the windows and other panels where a low color or crystal clear appearance is desirable. There is also a need for improved interlayers with very low color, and particularly low yellow color. There is also a need for interlayers having a low color or crystal clear appearance that can be used in combination with other interlayers and different glass types in laminated glass panels. Accordingly, there is a need in the art for the development of an interlayer having lower color tone or less yellowness for use in extra clear glazing applications without a reduction in optical, mechanical, and performance characteristics of an interlayer.

### SUMMARY OF THE INVENTION

Because of these and other problems in the art, described herein, among other things is a polymer interlayer that has improved color, such as an improved combination of a* and b*. In an embodiment, an interlayer comprises: poly(vinyl butyral) resin, a plasticizer, and at least one colorant, wherein the interlayer has improved properties such as low color or low yellowness index (YI). In an embodiment, a poly(vinyl butyral) interlayer comprises: poly(vinyl butyral) resin and at least one plasticizer, wherein the interlayer has color coordinates a* and b*, when measured on an interlayer having a thickness of 6.3 mm (as measured according to ASTM E1348 III. D65/10° Obs. CIELab), of −1<a*<0 and 0<b*<2.

In embodiments, the poly(vinyl butyral) interlayer has a yellowness index (YI) of from about −2.0 to about 2.0 when measured on an interlayer having a thickness of 6.3 mm, or has a yellowness index (YI) of from about −1.5 to 1.5 when measured on an interlayer having a thickness of 6.3 mm, or has a yellowness index (YI) of from about −1.0 to 1.0 when measured on an interlayer having a thickness of 6.3 mm, or has a yellowness index (YI) of from about −0.5 to 0.5 when measured on an interlayer having a thickness of 6.3 mm, or has a yellowness index (YI) of from about −1.0 to about 1.0 when measured on an interlayer having a thickness of 3.8 mm, or has a yellowness index (YI) of from about −0.5 to about 0.5 when measured on an interlayer having a thickness of 3.8 mm, or has a yellowness index (YI) of from about −0.4 to about 0.4 when measured on an interlayer having a thickness of 3.8 mm, or has a yellowness index (YI) of from about −1.0 to 1.0 when measured on an interlayer having a thickness of 0.76 mm, or has a yellowness index (YI) of from about −0.5 to 0.5 when measured on an interlayer having a thickness of 0.76 mm, or has a yellowness index (YI) of from about −0.4 to 0.4 when measured on an interlayer having a thickness of 0.76 mm, or has a yellowness index (YI) of from about 0.3 to 0.3 when measured on an interlayer having a thickness of 0.76 mm, or has a yellowness index (YI) of from about −0.20 to 0.20 when measured on an interlayer having a thickness of 0.76 mm (as measured according to ASTM E313 III C/2° obs).

In embodiments, the poly(vinyl butyral) interlayer has color coordinates a* and b*, when measured on an interlayer having a thickness of 6.3 mm, of 0.65<a*<0 and 0<b*<1.5, or has color coordinates a* and b*, when measured on an interlayer having a thickness of 6.3 mm, of −0.55<a*<0 and 0<b*<1.2, or has color coordinates a* and b*, when measured on an interlayer having a thickness of 6.3 mm, of −0.45<a*<0 and 0<b*<0.8, or has color coordinates a* and b*, when measured on an interlayer having a thickness of 6.3 mm, of −0.4<a*<0 and 0<b*<0.7, or has color coordinates a* and b*, when measured on an interlayer having a thickness of 6.3 mm (as measured according to ASTM E1348 III. D65/10° Obs. CIELab), of −0.3<a*<0 and 0<b*<0.4.

In embodiments, the interlayer has L*≥90, or L*≥90.5, or L*≥91, or L*≥91.5 when measured on a laminate having an interlayer with a thickness of 6.3 mm (as measured according to ASTM E1348 III. D65/10° Obs. CIELab).

In embodiments, the interlayer has L*≥92, or L*≥92.5, or L*≥93 when measured on a laminate having an interlayer with a thickness of 3.8 mm (as measured according to ASTM E1348 III. D65/10° Obs. CIELab).

In embodiments, the interlayer has L*≥94, or L*≥94.5, or L*≥95 when measured on a laminate having an interlayer with a thickness of 0.76 mm (as measured according to ASTM E1348 III. D65/10° Obs. CIELab).

In embodiments, the interlayer is a multilayer interlayer having at least two layers, or the interlayer is a multilayer interlayer having at least three layers, or the interlayer is a multilayer interlayer having more than three layers.

In another embodiment, a transparent multiple layer panel comprises: a first glass substrate, and a second glass substrate, wherein the first and second glass substrates consist of extra clear float glass having a thickness of 4 mm and color coordinates L*, a* and b* wherein L*=96.6, −0.20<a*<−0.15 and 0.08<b*<0.15, and the poly(vinyl butyral) interlayer previously described between the first and second substrates, wherein the multiple layer panel has color coordinates L*, a* and b*, wherein L*=92, a*=−0.7 and b*=0.7 (when measured according to ASTM E1348 III. D65/10° Obs. CIELab).

In another embodiment, a transparent multiple layer panel comprises: a first glass substrate, and a second glass substrate, wherein the first and second glass substrates consist of extra clear float glass having a thickness of 4 mm and color coordinates L*, a* and b* wherein L*=96.6, −0.20<a*<−0.15 and 0.08<b*<0.15, and the poly(vinyl butyral) interlayer previously described between the first and second substrates, wherein the multiple layer panel has color coordinates L*, a* and b*, wherein L*=93.5, a*=−0.6 and b*=0.6 (when measured according to ASTM E1348 III. D65/10° Obs. CIELab).

In another embodiment, a transparent multiple layer panel comprises: a first glass substrate, and a second glass substrate, wherein the first and second glass substrates consist of extra clear float glass having a thickness of 4 mm and color coordinates L*, a* and b* wherein L*=96.6, −0.20<a*<−0.15 and 0.08<b*<0.15, and the poly(vinyl butyral) interlayer previously described between the first and second substrates, wherein the multiple layer panel has color coordinates L*, a* and b*, wherein L*=95.7, a*=−0.45 and b*=0.3 (when measured according to ASTM E1348 III. D65/10° Obs. CIELab).

In embodiments, the multiple layer panel has a Luminous Transmittance (% T) of at least 80%, or the multiple layer panel has a Luminous Transmittance (% T) of at least 84%, or the multiple layer panel has a Luminous Transmittance (% T) of at least 89% (when measured according to ASTM D1003 and ASTM E1348 III. D65/10° Obs. CIELab).

In another embodiment, a multilayer panel comprises: a first glass substrate having a thickness of 6 mm, an interlayer comprising poly(vinyl butyral) resin and at least one plasticizer, wherein the panel has color coordinates a* and b*, wherein the panel has color coordinates a* and b*, wherein a*=−0.45 and b*=1.31 when measured on a panel having an interlayer thickness of 1.52 mm PVB, a second glass substrate having a thickness of 6 mm, wherein each of the 6 mm glass substrates has color coordinates a*=0.04 and b*=1.15, all measured according to ASTM E1348 III. D65/10° Obs. CIELab. In embodiments, the multilayer panel has a yellowness index (YI) wherein −0.5≤YI≤0.5 when measured according to ASTM E313 III C/2° obs, on a panel having an interlayer having a thickness of 1.52 mm.

In another embodiment, a multilayer panel comprises a first glass substrate having a thickness of 6 mm, an interlayer comprising poly(vinyl butyral) resin and at least one plasticizer, wherein the panel has color coordinates a* and b*, wherein a*=−0.31 and b*=1.31 when measured on a panel having an interlayer with a thickness of 0.76 mm, a second glass substrate having a thickness of 6 mm, wherein each of the 6 mm glass substrates has color coordinates a*=0.04 and b*=1.15, all measured according to ASTM E1348 III. D65/10° Obs. CIELab. In embodiments, the multilayer panel has a yellowness index (YI) wherein −0.25≤YI≤0.25 when measured according to ASTM E313 III C/2° obs, on an interlayer having a thickness of 0.76 mm.

In embodiments, the multiple layer panel has an L*≥97.5 and a luminous transmittance (% T) of at least 95%, or an L*≥97.0 a luminous transmittance (% T) of at least 94%, when measured according to ASTM D1003 and ASTM E1348 III D65/10° Obs. CIELab.

In embodiments, the interlayer is a multilayer interlayer having at least one layer of 0.76 mm thickness, or the interlayer is a multilayer interlayer having at least two layers of 0.76 mm thickness.

In another embodiment, a transparent multiple layer panel comprises: a first rigid substrate comprising float glass having a nominal thickness of 6 mm having color coordinates L*, a* and b*, wherein L*=97.7, a*=−0.05, b*=0.7, a second rigid substrate comprising float glass having a nominal thickness of 6 mm having color coordinates L*, a* and b*, wherein L*=97.7, a*=−0.05, b*=0.7, and a poly(vinyl butyral) interlayer having a nominal thickness of 0.76 mm between the first and second substrates, wherein the multiple layer panel has color coordinates L*, a* and b*, wherein L*≥97.5, 0<a*<−0.4 and 0<b*<1.5, and wherein the interlayer has color coordinates a* and b* of 0<a*<0.48 and 0<b*<0.6 when measured according to ASTM E1348 III. D65/10° Obs. CIELab.

In another embodiment, a transparent multiple layer panel comprises: a first rigid substrate comprising float glass having a nominal thickness of 6 mm having color coordinates L*, a* and b*, wherein L*=97.7, a*=−0.05, b*=0.7, a second rigid substrate comprising float glass having a nominal thickness of 6 mm having color coordinates L*, a* and b*, wherein L*=97.7, a*=−0.05, b*=0.7, and a poly(vinyl butyral) interlayer having a nominal thickness of 1.52 mm between the first and second substrates, wherein the multiple layer panel has color coordinates L*, a* and b*, wherein L*≥97.5, 0<a*<−0.48 and 0<b*<1.5, and wherein the interlayer has color coordinates a* and b* of 0<a*<0.25 and 0<b*<0.35 when measured according to ASTM E1348 III. D65/10° Obs. CIELab.

In an additional embodiment, a method for making an improved color poly(vinyl butyral) sheet comprises: providing a poly(vinyl butyral) resin; providing a plasticizer; providing at least one additive in an amount sufficient to reduce the color of the poly(vinyl butyral) sheet; melt blending the poly(vinyl butyral) resin, the plasticizer and the additive to create a poly(vinyl butyral) melt blend; and extruding the poly(vinyl butyral) melt blend into a poly(vinyl butyral) sheet; wherein the poly(vinyl butyral) sheet has color coordinates a* and b*, when measured on an sheet having a thickness of 6.3 mm (as measured according to ASTM E1348 III. D65/10° Obs. CIELab), of −1<a*<0 and 0<b*<2. In embodiments, the poly(vinyl butyral) sheet has a yellowness index (YI) of from about −2.0 to about 2.0 when measured on an interlayer having a thickness of 6.3 mm. In other embodiments, the poly(vinyl butyral) sheet has color coordinates and/or a yellowness index within any of the previously described ranges.

In embodiments, the interlayer comprises a single layer, and in other embodiments, the interlayer comprises multiple layers, such as two layers, three layers, or four or more layers.

In certain embodiments, the rigid substrate (or substrates) is glass. In other embodiments, the panel may further comprise a photovoltaic cell, with the interlayer encapsulating the photovoltaic cell. In other embodiments, the panel may further comprise a film, with or without coatings, such as reflective coatings or coatings that absorb UV.

### BRIEF DESCRIPTION OF THE DRAWINGS

FIG. 1 provides a graphical illustration of the color coordinates and the range wherein the color can be tuned.

FIG. 2 provides a graphical illustration in more detail of the area of interest to have low color or low yellowness.

### DESCRIPTION OF THE PREFERRED EMBODIMENT(S)

Described herein, among other things, are interlayers comprised of a thermoplastic resin, a plasticizer, and at least one additive, wherein the interlayer has a low yellowness and crystal clear appearance, good optical properties and minimal change or reduction in other properties such that the other properties are acceptable.

Due to the presence of a certain amount of yellowness or yellow color in the polymer (such as PVB) interlayer, customers sometimes find this objectionable when an extra clear glazing is to be used in an application, such as an architectural application. The inventors have found that it is possible to reduce the yellowness (or lower the level of yellow color) to produce a more color neutral polymer material by the addition of colorants in a ratio and concentration selected such that the resulting color of the PVB has little or no yellow color. As used herein, low color or low yellowness refers generally to an interlayer having a yellowness index of 0<YI<2. By adding certain colorants to the polymer interlayer, it is possible to change the a* and b* values of the polymer sheet, as further described below. This same principle of using a combination of different colorants to change or control color could be used to control the color of the polymer sheet to a different range of color coordinates if desired (that is, close to a* and b* values of 0, 0).

In an embodiment, an interlayer comprises: poly(vinyl butyral) resin, a plasticizer, and at least one additive, such as a colorant, pigment or dye, wherein the interlayer has a YI between 0.0 and 0.2 (as measured by ASTM E313).

In an embodiment, a poly(vinyl butyral) interlayer comprises: poly(vinyl butyral) resin and at least one plasticizer, wherein the interlayer has color coordinates a* and b*, when measured on an interlayer having a thickness of 6.3 mm (as measured according to ASTM E1348 III. D65/10° Obs. CIELab), of −1<a*<0 and 0<b*<2.

In embodiments, the poly(vinyl butyral) interlayer has a yellowness index (YI) of from about −2.0 to about 2.0 when measured on an interlayer having a thickness of 6.3 mm, or has a yellowness index (YI) of from about −1.0 to about 1.0 when measured on an interlayer having a thickness of 3.8 mm, or has a yellowness index (YI) of from about −1.0 to 1.0 when measured on an interlayer having a thickness of 0.76 mm (as measured according to ASTM E313 III C/2° obs).

In embodiments, the interlayer has L*≥90 when measured on a laminate having an interlayer with thickness of 6.3 mm (as measured according to ASTM E1348 III. D65/10° Obs. CIELab). In embodiments, the interlayer has L*≥92 when measured on a laminate having an interlayer with thickness of 3.8 mm (as measured according to ASTM E1348 III. D65/10° Obs. CIELab). In embodiments, the interlayer has L*≥94 when measured on a laminate having an interlayer with a thickness of 0.76 mm (as measured according to ASTM E1348 III. D65/10° Obs. CIELab).

In embodiments, the interlayer is a multilayer interlayer having at least two layers, or the interlayer is a multilayer interlayer having at least three layers, or the interlayer is a multilayer interlayer having more than three layers.

In another embodiment, a transparent multiple layer panel comprises: a first glass substrate, and a second glass substrate, wherein the first and second glass substrates consist of extra clear float glass having a thickness of 4 mm and color coordinates L*, a* and b* wherein L*=96.6, −0.20<a*<−0.15 and 0.08<b*<0.15, and the poly(vinyl butyral) interlayer of claim 1 between the first and second substrates, wherein the multiple layer panel has color coordinates L*, a* and b*, wherein L*=92, a*=−0.7 and b*=0.7 (when measured according to ASTM E1348 III. D65/10° Obs. CIELab).

In another embodiment, a transparent multiple layer panel comprises: a first glass substrate, and a second glass substrate, wherein the first and second glass substrates consist of extra clear float glass having a thickness of 4 mm and color coordinates L*, a* and b* wherein L*=96.6, −0.20<a*<−0.15 and 0.08<b*<0.15, and the poly(vinyl butyral) interlayer of claim 2 between the first and second substrates, wherein the multiple layer panel has color coordinates L*, a* and b*, wherein L*=93.5, a*=−0.6 and b*=0.6 (when measured according to ASTM E1348 III. D65/10° Obs. CIELab).

In another embodiment, a transparent multiple layer panel comprises: a first glass substrate, and a second glass substrate, wherein the first and second glass substrates consist of extra clear float glass having a thickness of 4 mm and color coordinates L*, a* and b* wherein L*=96.6, −0.20<a*<−0.15 and 0.08<b*<0.15, and the poly(vinyl butyral) interlayer of claim 3 between the first and second substrates, wherein the multiple layer panel has color coordinates L*, a* and b*, wherein L*=95.7, a*=−0.45 and b*=0.3 (when measured according to ASTM E1348 III. D65/10° Obs. CIELab).

In embodiments, the multiple layer panel has a Luminous Transmittance (% T) of at least 80 (when measured according to ASTM D1003 and ASTM E1348 III. D65/10° Obs. CIELab).

In another embodiment, a multilayer panel comprises: a first glass substrate having a thickness of 6 mm, an interlayer comprising poly(vinyl butyral) resin and at least one plasticizer, and a second glass substrate having a thickness of 6 mm, wherein each of the 6 mm glass substrates has color coordinates a*=0.04 and b*=1.15, wherein the panel has color coordinates a* and b* values when measured on a panel having an interlayer thickness of 1.52 mm PVB of a*=−0.45 and b*=1.31, all measured according to ASTM E1348 III. D65/10° Obs. CIELab. In embodiments, the multilayer panel has a yellowness index (YI) wherein −0.5≤ YI≤ 0.5 when measured according to ASTM E313 III C/2° obs, on a panel having an interlayer having a thickness of 1.52 mm.

In another embodiment, a multilayer panel comprises a first glass substrate having a thickness of 6 mm, an interlayer comprising poly(vinyl butyral) resin and at least one plasticizer, and a second glass substrate having a thickness of 6 mm, wherein each of the 6 mm glass substrates has color coordinates a*=0.04 and b*=1.15, wherein the panel has color coordinates a* and b* values when measured on a panel having an interlayer with a thickness of 0.76 mm of a*=−0.31 and b*=1.31, all measured according to ASTM E1348 III. D65/10° Obs. CIELab. In embodiments, the multilayer panel has a yellowness index (YI) wherein −0.25≤YI≤0.25 when measured according to ASTM E313 III C/2° obs, on an interlayer having a thickness of 0.76 mm.

In embodiments, the multiple layer panel has an L*≥97.5 and a luminous transmittance (% T) of at least 95%, or an L*≥97.0 a luminous transmittance (% T) of at least 94%, when measured according to ASTM D1003 and ASTM E1348 III D65/10° Obs. CIELab. In embodiments, the interlayer is a multilayer interlayer having at least one layer of 0.76 mm thickness, or the interlayer is a multilayer interlayer having at least two layers of 0.76 mm thickness.

In another embodiment, a transparent multiple layer panel comprises: a first rigid substrate comprising float glass having a nominal thickness of 6 mm having color coordinates L*, a* and b*, wherein L*=97.7, a*=−0.05, b*=0.7, a second rigid substrate comprising float glass having a nominal thickness of 6 mm having color coordinates L*, a* and b*, wherein L*=97.7, a*=−0.05, b*=0.7, and a poly(vinyl butyral) interlayer having a nominal thickness of 0.76 mm between the first and second substrates, wherein the multiple layer panel has color coordinates L*, a* and b*, wherein L*≥97.5, 0<a*<−0.4 and 0<b*<1.5, and wherein the interlayer has color coordinates a* and b* of 0<a*<0.48 and 0<b*<0.6 when measured according to ASTM E1348 III. D65/10° Obs. CIELab.

In another embodiment, a transparent multiple layer panel comprises: a first rigid substrate comprising float glass having a nominal thickness of 6 mm having color coordinates L*, a* and b*, wherein L*=97.7, a*=−0.05, b*=0.7, a second rigid substrate comprising float glass having a nominal thickness of 6 mm having color coordinates L*, a* and b*, wherein L*=97.7, a*=−0.05, b*=0.7, and a poly(vinyl butyral) interlayer having a nominal thickness of 1.52 mm between the first and second substrates, wherein the multiple layer panel has color coordinates L*, a* and b*, wherein L*≥97.5, 0<a*<−0.48 and 0<b*<1.5, and wherein the interlayer has color coordinates a* and b* of 0<a*<0.25 and 0<b*<0.35 when measured according to ASTM E1348 III. D65/10° Obs. CIELab.

The use of a poly(vinyl acetal) resin, such as poly(vinyl butyral resin, a plasticizer, and at least one additive, when melt-extruded, creates an interlayer having a low yellow color without sacrificing other physical and optical characteristics. As used herein, “lower color”, “neutral color” and “crystal clear” mean having less yellow color or a lower yellowness index (YI) and a color centered around a* and b* values and as close as possible to 0, preferably having b*>0 and a*<0, although in other embodiments, depending on the desired properties, color coordinates may include b*<0 and a*<0, b*<0 and a*>0 and b*>0 and a*>0, as long as a* and b* are substantially close to 0. The terms lower color, neutral color and crystal clear all refer to the yellowness or yellow color (or lack of) and may be used interchangeably throughout this description.

As previously described, attempts to provide a less yellow appearance to interlayers have been made by addition of additives such as stabilizers and optical brighteners to the formulations in an attempt to reduce the yellowness or yellow color. Examples of previous attempts to reduce yellowness can be found, for example, in Liu, R., He, B. & Chen, X. 2008. Degradation of poly(vinyl butyral) and its stabilization by bases. Polymer Degradation and Stability 93(4): 846-853; U.S. Publication No. 20140371356 A1; and U.S. Pat. No. 5,573,842. Addition of an optical brightener, which is often considered a ‘blue’ compound, to compensate for or reduce the yellow color often makes the resultant polymer look green. Additionally, attempts have been made to limit the contributions to the yellowness of the individual components by modifying the manufacturing process, but it is not practical to eliminate all yellowness or yellow color in this way.

The inventors have discovered that it is possible to lower the color (as determined by a* and b* values) and reduce the yellow appearance (as determined by YI value) to produce a more color neutral PVB material by the addition of colorants with the other raw materials (such as PVB and plasticizer), in a ratio and concentration selected such that the resulting color of the PVB has little or no yellowness (0<YI<2). A polymer interlayer having good optical quality and improved color (lower color or extra clear) may be produced. By using the addition of certain colorants, it is possible to control the a* and b* values of the PVB sheet, as further described below.

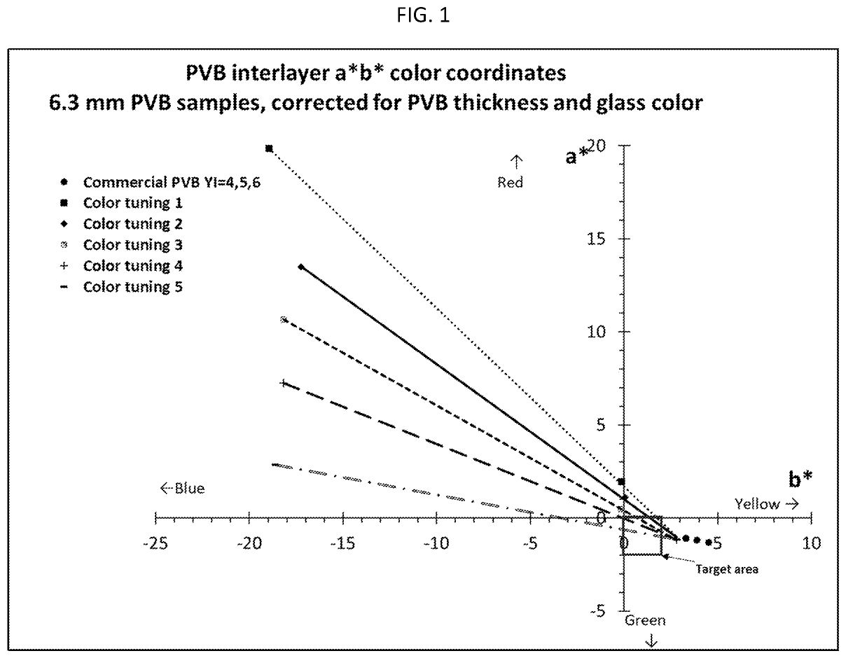

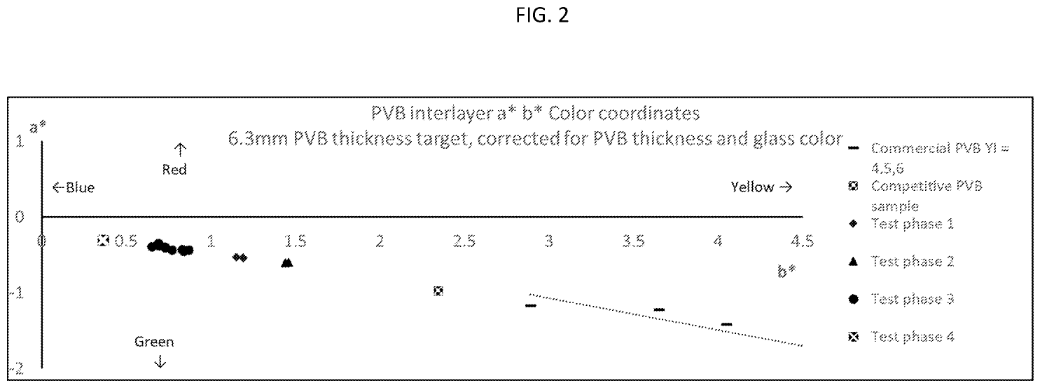

FIG. 1 shows that by adding certain additives, such as colorants, the color coordinates a*, b* and L* can be controlled and, if additives are added in an appropriate amount, a polymer sheet having a reduced color with low yellow coordinate b* can be produced. As shown by FIG. 2, examples of the invention have a* and b* values close to 0 while other interlayer sheet, such as a commercially available PVB sheet without the additives have color coordinates having much higher a* and b* values. Having the higher a* and b* values leads to undesirable high color (i.e., yellowness).

Some terminology used throughout this application will be explained to provide a better understanding of the invention. The terms “polymer interlayer sheet,” “interlayer,” and “polymer melt sheet” as used herein, generally may designate a single-layer sheet or a multilayered interlayer. A “single-layer sheet,” as the names implies, is a single polymer layer extruded as one layer. A multilayered interlayer, on the other hand, may comprise multiple layers, including separately extruded layers, co-extruded layers, or any combination of separately and co-extruded layers. Thus the multilayered interlayer could comprise, for example: two or more single-layer sheets combined together (“plural-layer sheet”); two or more layers co-extruded together (“co-extruded sheet”); two or more co-extruded sheets combined together; a combination of at least one single-layer sheet and at least one co-extruded sheet; and a combination of at least one plural-layer sheet and at least one co-extruded sheet. In various embodiments of the present disclosure, a multilayered interlayer comprises at least two polymer layers (e.g., a single layer or multiple layers co-extruded) disposed in direct contact with each other, wherein each layer comprises a polymer resin, as detailed more fully below. As used herein, “skin layer” generally refers to outer layers of the multilayered interlayer and “core layer” generally refers to the inner layer(s). Thus, one exemplary embodiment would be: skin layer//core layer//skin layer. It should be noted, however, further embodiments include interlayers having more than three layers (e.g., 4, 5, 6, or up to 10 individual layers). Additionally, any multilayer interlayer utilized can be varied by manipulating the composition, thickness, or positioning of the layers and the like. For example, in one trilayer polymer interlayer sheet, the two outer or skin layers may comprise poly(vinyl butyral) (“PVB”) resin with a plasticizer or mixture of plasticizers, while the inner or core layer may comprise the same or different PVB resin or different thermoplastic material with a plasticizer and/or mixture of plasticizers. Thus, it is contemplated that the skin layers and the core layer(s) of the multilayered interlayer sheets may be comprised of the same thermoplastic material or different thermoplastic materials. Either or both layers may include additional additives as known in the art, as desired.

Although the embodiments described below refer to the polymer resin as being PVB, it would be understood by one of ordinary skill in the art that the polymer may be any poly(vinyl acetal) polymer suitable for use in a multiple layer panel. PVB is particularly desirable when used in conjunction with the interlayers of this disclosure for use in windows and other glazing applications.

Some common components found in an interlayer, both generally and in interlayers of the present disclosure, and the formation thereof will be discussed. The PVB resin is produced by known aqueous or solvent acetalization processes by reacting polyvinyl alcohol (“PVOH”) with butyraldehyde in the presence of an acid catalyst, separation, stabilization, and drying of the resin. Such acetalization processes are disclosed, for example, in U.S. Pat. Nos. 2,282,057 and 2,282,026 and Wade, B. 2016, Vinyl Acetal Polymers, Encyclopedia of Polymer Science and Technology. 1-22 (online, copyright 2016 John Wiley & Sons, Inc.), the entire disclosures of which are incorporated herein by reference. The resin is commercially available in various forms, for example, as Butvar® Resin from Eastman Chemical Company.

As used herein, residual hydroxyl content (calculated as PVOH) refers to the amount of hydroxyl groups remaining on the polymer chains after processing is complete. For example, PVB can be manufactured by hydrolyzing poly(vinyl acetate) to PVOH, and then reacting the PVOH with butyraldehyde. In the process of hydrolyzing the poly(vinyl acetate), typically not all of the acetate side groups are converted to hydroxyl groups. Further, reaction with butyraldehyde typically will not result in all hydroxyl groups being converted to acetal groups. Consequently, in any finished poly(vinyl butyral) resin, there typically will be residual acetate groups (as vinyl acetate groups) and residual hydroxyl groups (as vinyl hydroxyl groups) as side groups on the polymer chain. As used herein, residual hydroxyl content is measured on a weight percent basis per ASTM 1396.

In various embodiments, the poly(vinyl butyral) resin comprises about 8 to about 35 weight percent (wt. %) hydroxyl groups calculated as PVOH, depending on the desired properties of the interlayer. In embodiments, the resin (or at least one resin) may comprise about 10 to 30 wt. %, or about 15 to 25 wt. % hydroxyl groups calculated as PVOH, although other amounts are possible depending on the desired properties. The resin can also comprise less than 15 wt. % residual ester groups, less than 13 wt. %, less than 11 wt. %, less than 9 wt. %, less than 7 wt. %, less than 5 wt. %, or less than 1 wt. residual ester groups calculated as polyvinyl ester, e.g., acetate, with the balance being an acetal, such as butyraldehyde acetal, but optionally being other acetal groups, such as a 2-ethyl hexanal acetal group, or a mix of butyraldehyde acetal, isobutyraldehyde acetal and 2-ethyl hexanal acetal groups (see, for example, U.S. Pat. No. 5,137,954, the entire disclosure of which is incorporated herein by reference).

For a given type of plasticizer, the compatibility of the plasticizer in the polymer is largely determined by the hydroxyl content of the polymer. Polymers with greater residual hydroxyl content are typically correlated with reduced plasticizer compatibility or capacity. Conversely, polymers with a lower residual hydroxyl content typically will result in increased plasticizer compatibility or capacity. Generally, this correlation between the residual hydroxyl content of a polymer and plasticizer compatibility/capacity can be manipulated and exploited to allow for addition of the proper amount of plasticizer to the polymer resin and to stably maintain differences in plasticizer content between multiple interlayers.

The PVB resin (or resins) of the present disclosure typically has a molecular weight of greater than 50,000, about 50,000 to about 500,000 Daltons, about 70,000 to about 500,000 Daltons, about 80,000 to about 250,000 Daltons, less than about 500,000 Daltons, or less than about 250,000 Daltons, as measured by size exclusion chromatography using low angle laser light scattering. As used herein, the term “molecular weight” means the weight average molecular weight.

Other additives may be incorporated into the interlayer to enhance its performance in a final product and impart certain additional properties to the interlayer as long as the additives do not adversely affect the color and other properties desired. Such additives include, but are not limited to, adhesion control agents (“ACAs”), dyes, other pigments (such as color pigments or titanium dioxide), stabilizers (e.g., ultraviolet stabilizers), antioxidants, anti-blocking agents, flame retardants, IR absorbers or blockers (e.g., indium tin oxide, antimony tin oxide, lanthanum hexaboride (LaB₆) and cesium tungsten oxide), processing aides, flow enhancing additives, lubricants, impact modifiers, nucleating agents, thermal stabilizers, UV absorbers, UV stabilizers, dispersants, surfactants, chelating agents, coupling agents, adhesives, primers, reinforcement additives, and fillers, among other additives known to those of ordinary skill in the art.

In various embodiments of interlayers of the present disclosure, the interlayer will comprise about 5 to about 100 phr (parts per hundred parts resin) total plasticizer. As used herein, the amount of plasticizer, or any other component in the interlayer, can be measured as parts per hundred parts resin (phr), on a weight per weight basis. For example, if 30 grams of plasticizer is added to 100 grams of polymer resin, then the plasticizer content of the resulting plasticized polymer would be 30 phr. As used herein, when the plasticizer content of the interlayer is given, the plasticizer content is determined with reference to the phr of the plasticizer in the melt that was used to produce the interlayer.

Examples of suitable plasticizers for use in these interlayers include esters of a polybasic acid or a polyhydric alcohol, among others. Suitable plasticizers include, for example, triethylene glycol di-(2-ethylhexanoate) (“3GEH”), tetraethylene glycol di-(2-ethylhexanoate), triethylene glycol di-(2 ethylbutyrate), triethylene glycol diheptanoate, tetraethylene glycol diheptanoate, dihexyl adipate, dioctyl adipate, hexyl cyclohexyladipate, diisononyl adipate, heptylnonyl adipate, dibutyl sebacate, and mixtures thereof. In some embodiments, the plasticizer is 3GEH.

In other embodiments, a high refractive index plasticizer may be used, either alone or in combination with another plasticizer such as 3GEH. As used herein, a “high refractive index plasticizer” is a plasticizer having a refractive index of at least about 1.460. The refractive index of a commonly used plasticizer, such as 3GEH, is about 1.442, and the refractive indices of many other conventional plasticizers are from about 1.442 to about 1.449. Examples of plasticizers having a high refractive index that may be used in a polymer interlayer include, but are not limited to, polyadipates (RI of about 1.460 to about 1.485); epoxides such as epoxidized soybean oils (RI of about 1.460 to about 1.480); phthalates and terephthalates (RI of about 1.480 to about 1.540); benzoates (RI of about 1.480 to about 1.550); and other specialty plasticizers (RI of about 1.490 to about 1.520). The refractive index of poly(vinyl butyral) resin is approximately 1.485 to 1.495. Examples of high refractive index plasticizers include, but are not limited to, esters of a polybasic acid or a polyhydric alcohol, polyadipates, epoxides, phthalates, terephthalates, benzoates, toluates, mellitates and other specialty plasticizers, among others. Examples of suitable plasticizers include, but are not limited to, dipropylene glycol dibenzoate, tripropylene glycol dibenzoate, polypropylene glycol dibenzoate, isodecyl benzoate, 2-ethylhexyl benzoate, diethylene glycol benzoate, propylene glycol dibenzoate, 2,2,4-trimethyl-1,3-pentanediol dibenzoate, 2,2,4-trimethyl-1,3-pentanediol benzoate isobutyrate, 1,3-butanediol dibenzoate, diethylene glycol di-o-toluate, triethylene glycol di-o-toluate, dipropylene glycol di-o-toluate, 1,2-octyl dibenzoate, tri-2-ethylhexyl trimellitate, di-2-ethylhexyl terephthalate, bis-phenol A bis(2-ethylhexaonate), ethoxylated nonylphenol, and mixtures thereof. In some embodiments, examples of high refractive index plasticizers are dipropylene glycol dibenzoate, 2,2,4-trimethyl-1,3-pentanediol dibenzoate, and tripropylene glycol dibenzoate.

It is contemplated that polymer interlayer sheets as described herein may be produced by any suitable process known to one of ordinary skill in the art of producing polymer interlayer sheets that are capable of being used in a multiple layer panel (such as a glass laminate or glass panel). For example, it is contemplated that the polymer interlayer sheets may be formed through solution casting, compression molding, injection molding, melt extrusion, melt blowing or any other procedures for the production and manufacturing of a polymer interlayer sheet known to those of ordinary skill in the art. Further, in embodiments where multiple polymer interlayers are utilized, it is contemplated that these multiple polymer interlayers may be formed through co-extrusion, blown film, dip coating, solution coating, blade, paddle, air-knife, printing, powder coating, spray coating or other processes known to those of ordinary skill in the art. While all methods for the production of polymer interlayer sheets known to one of ordinary skill in the art are contemplated as possible methods for producing the polymer interlayer sheets described herein, this application will focus on polymer interlayer sheets produced through the extrusion and co-extrusion processes. The final multiple layer glass panel laminates of the present invention are formed using processes known in the art.

Generally, in its most basic sense, extrusion is a process used to create objects of a fixed cross-sectional profile. This is accomplished by pushing or drawing a material through a die of the desired cross-section for the end product. Generally, in the extrusion process, thermoplastic resin and plasticizers, including any of those resins, plasticizers and other additives described above, are pre-mixed and fed into an extruder device. Any additives such as colorants and UV inhibitors (in liquid, powder, or pellet form) are often used and can be mixed into the thermoplastic resin or plasticizer prior to arriving in the extruder device. These additives are incorporated into the thermoplastic polymer resin, and by extension the resultant polymer interlayer sheet, to enhance certain properties of the polymer interlayer sheet and its performance in the final multiple layer glass panel product.

In the extruder device, the particles of the thermoplastic raw material, plasticizer, pigment(s) and any other additives described above, are further mixed and melted, resulting in a melt that is generally uniform in temperature and composition. Once the melt reaches the end of the extruder device, the melt is propelled into the extruder die. The extruder die is the component of the thermoplastic extrusion process which gives the final polymer interlayer sheet product its profile. Generally, the die is designed such that the melt evenly flows from a cylindrical profile coming out of the die and into the product's end profile shape. A plurality of shapes can be imparted to the end polymer interlayer sheet by the die so long as a continuous profile is present.

The polymer interlayer at the state after the extrusion die forms the melt into a continuous profile will be referred to as a “polymer melt sheet.” At this stage in the process, the extrusion die has imparted a particular profile shape to the thermoplastic resin, thus creating the polymer melt sheet. The polymer melt sheet is highly viscous throughout and in a generally molten state. In the polymer melt sheet, the melt has not yet been cooled to a temperature at which the sheet generally completely “sets.” Thus, after the polymer melt sheet leaves the extrusion die, generally the next step in presently employed thermoplastic extrusion processes is to cool the polymer melt sheet with a cooling device. Cooling devices utilized in the previously employed processes include, but are not limited to, spray jets, fans, cooling baths, and cooling rollers. The cooling step functions to set the polymer melt sheet into a polymer interlayer sheet of a generally uniform non-molten cooled temperature. In some embodiments, the polymer melt sheet may be embossed after leaving the die, and prior to the cooling step, as previously discussed. In contrast to the polymer melt sheet, this polymer interlayer sheet is not in a molten state and is not highly viscous. Rather, it is the set final-form cooled polymer interlayer sheet product. For the purposes of this application, this set and cooled polymer interlayer will be referred to as the “polymer interlayer sheet.”

In some embodiments of the extrusion process, a co-extrusion process may be utilized. Co-extrusion is a process by which multiple layers of polymer material are extruded simultaneously. Generally, this type of extrusion utilizes two or more extruders to melt and deliver a steady volume throughput of different thermoplastic melts of different viscosities or other properties through a co-extrusion die into the desired final form. The thickness of the multiple polymer layers leaving the extrusion die in the co-extrusion process can generally be controlled by adjustment of the relative speeds of the melt through the extrusion die and by the sizes of the individual extruders processing each molten thermoplastic resin material.

Generally, the thickness, or gauge, of the polymer interlayer sheet or any of the layers or interlayers can be at least about 2, at least about 5, at least about 10, at least about 15, at least about 20 mils and/or not more than about 120, not more than about 100, not more than about 90, not more than about 60, not more than about 50, or not more than about 35 mils, or it can be in the range of from about 2 to about 120, about 10 to about 100, about 15 to about 60, or about 20 to about 35 mils, although other thicknesses may be appropriate depending on the desired properties and/or application. In millimeters, the thickness of the polymer layers or interlayers can be at least about 0.05, at least about 0.13, at least about 0.25, at least about 0.38, at least about 0.51 mm and/or not more than about 2.74, not more than about 2.54, not more than about 2.29, not more than about 1.52, or not more than about 0.89 mm, or in the range of from about 0.05 to 2.74, about 0.25 to about 2.54 mm, about 0.38 to about 1.52 mm, or about 0.51 to about 0.89 mm, although other thicknesses may be appropriate depending on the desired properties and/or application.

As noted above, the interlayers of the present disclosure may be used as a single-layer sheet or a multilayered sheet. The interlayers having improved or lower color may be used with one or more clear or colored interlayers to provide the desired laminate color(s) and appearance. In various embodiments, the interlayers of the present disclosure (either as a single-layer sheet, a multilayered sheet, or as one or more layers of the same or different materials) can be incorporated into a multiple layer panel, such as a transparent multiple layer panel.

As used herein, a multiple layer panel can comprise a single substrate, such as glass, acrylic, or polycarbonate with a polymer interlayer sheet disposed thereon, and most commonly, with a polymer film further disposed over the polymer interlayer. The combination of polymer interlayer sheet and polymer film is commonly referred to in the art as a bilayer. A typical multiple layer panel with a bilayer construct is: (glass)//(polymer interlayer sheet)//(polymer film), where the polymer interlayer sheet can comprise multiple interlayers, as noted above. The polymer film supplies a smooth, thin, rigid substrate that affords better optical character than that usually obtained with a polymer interlayer sheet alone and functions as a performance enhancing layer. Polymer films differ from polymer interlayer sheets, as used herein, in that polymer films do not themselves provide the necessary penetration resistance and glass retention properties, but rather provide performance improvements, such as infrared absorption characteristics. Poly(ethylene terephthalate) (“PET”) is the most commonly used polymer film.

The interlayers of the present disclosure will most commonly be utilized in multiple layer panels comprising two substrates, preferably a pair of glass sheets (or other rigid materials, such as polycarbonate or acrylic, known in the art), with the interlayers disposed between the two substrates. An example of such a construct would be: (glass)//(polymer interlayer sheet)//(glass), where the polymer interlayer sheet can comprise multilayered interlayers or multiple different single or multilayer interlayers, as noted above, and wherein at least one of the polymer interlayers (or layers therein) comprises the improved interlayer. These examples of multiple layer panels are in no way meant to be limiting, as one of ordinary skill in the art would readily recognize that numerous constructs other than those described above could be made with the interlayers of the present disclosure.

A typical glass lamination process comprises the following steps: (1) assembly of the two substrates (e.g., glass) and interlayer; (2) heating the assembly via an IR radiant or convective means for a short period; (3) passing the assembly into a pressure nip roll for the first deairing; (4) heating the assembly a second time, such as at a temperature of about 70° C. to about 120° C. to give the assembly enough temporary adhesion to seal the edge of the interlayer; (5) passing the assembly into a second pressure nip roll to further seal the edge of the interlayer and allow further handling; and (6) autoclaving the assembly, for example at temperatures between 135° C. and 150° C. and pressures between 150 psig and 200 psig for about 30 to 90 minutes.

One parameter often used to describe the polymer interlayers is the clarity, which is determined by measuring the haze value or percent haze (% Haze). Light that is scattered upon passing through a film or sheet of a material can produce a hazy or smoky field when objects are viewed through the material. Thus, the haze value is a quantification of the scattered light by a sample in contrast to the incident light. The test for percent haze is performed with a spectrophotometer such as the Ultrascan XE or Ultrascan PRO available from Hunter Associates (Reston, Va.), and in accordance with ASTM D1003−13 Procedure B using Illuminant C, at an observer angle of 2 degrees. The interlayers of the present disclosure also have a typical luminous transmittance (% T) of at least 85% or from at least 85 to 95% or more (as measured on the HunterLab Ultrascan XE) depending on PVB thickness and the type of glass used. In embodiments, the % T may be at least 86%, at least 87%, at least 88%, at least 89%, or at least 90% or more, especially if the interlayer is laminated between two pieces of low iron glass. The interlayers of the present invention desirably have a* of about −0.1 and b* of about 0.1 when the interlayer is a single or mono layer. Other values may be possible depending on the desired level of color, thickness, end use as well as other factors.

### EXAMPLES

Samples of interlayer sheet having improved lower color were produced by mixing and melt-extruding PVB resin, plasticizer and colorants, along with other common additives (including adhesion control agents and a UV stabilizer). The mix was extruded to form an interlayer sheet having a thickness of about 0.76 mm (30 gauge (30 mils)).

To test the resultant interlayers, multiple layers were stacked and pressed to form a target thickness for measurement of YI and L*a*b* values. For the target or nominal thickness of about 6.3 mm, ten (10) layers were stacked, and for a target thickness of 3.8 mm, five (5) layers were stacked before pressing to target thickness, as further described below. Measurements were also made on single layers of PVB as shown below. The actual PVB thickness is noted in the Tables.

In some Tables, the PVB a* and b* values are displayed. These values were obtained by calculation. To calculate a* and b* of the interlayer, the glass to be used was measured prior to lamination, and then measurements on the laminate (i.e. glass/interlayer(s)/glass) were made, and the difference was calculated as further described below. The resulting polymer interlayers had the properties shown in Tables 1 to 5.

The interlayer color and YI values were calculated by measuring the properties of the glass to be used and then measuring the laminate sample (the interlayer(s) laminated between two pieces of glass). The color of the laminate is equal to the color of the glass used plus the color of the interlayer. If the color of the glass is known (i.e., measured as glass only prior to lamination), then the color of the interlayer is equal to difference between the color of the laminate and the color of the glass. The glass color and laminate color were measured by the same method according to ASTM method E1348.

Multiple samples in different thicknesses (or numbers of layers) were measured to determine the color and yellowness index (YI) of the interlayers. The interlayers were measured as single layers, as stacks of five laminated together and in pressed stacks of ten layers. For the single layer and five layer samples, the interlayer(s) was placed between two glass pieces of the desired size, it was pre-pressed to remove air, and then laminated. For the ten layer samples, the interlayers were placed between two glass pieces of the desired size and placed between a mechanical press and fused together to a target thickness of 6.3 mm of PVB.

Table 1 shows the properties of standard, commercially available PVB using 10 layers in combination with different types of glass and different glass thicknesses. The measured YI was corrected for PVB thickness as follows:

YI_{corrected}=(YI_{measured}*6.3)/PVB thickness.

TABLE 1
standard PVB (pressed stacks of 10 layers having a nominal thickness of 6.3 mm)

| | | | YI | | | | | | |
|---|---|---|---|---|---|---|---|---|---|
| | Laminate | PVB | (Corrected | | | | | | |
| | thickness | thickness | for PVB | | | | | PVB | PVB |
| | (mm) | (mm) | thickness) | L* | a* | b* | % T | a* | b* |
| Sample 1A | 13.96 | 6.06 | 5.7 | 95.77 | −1.37 | 3.58 | 89.47 | −1.03 | 3.33 |
| Sample 1B | 13.99 | 6.29 | 4.9 | 94.38 | −2.37 | 3.77 | 86.17 | −1.12 | 3.27 |
| Sample 1C | 16.39 | 6.59 | 5.3 | 95.76 | −1.55 | 3.74 | 89.44 | −0.86 | 3.07 |
| Sample 1 | 10.5 | 6.0 | 4.3 | 95.13 | −2.46 | 3.34 | 87.93 | −1.18 | 2.89 |
| Sample 2A | 13.89 | 5.99 | 6.9 | 95.65 | −1.42 | 4.25 | 89.18 | −1.08 | 4.0 |
| Sample 2B | 13.86 | 6.16 | 6.3 | 94.25 | −2.42 | 4.44 | 85.85 | −1.17 | 3.94 |
| Sample 2C | 16.28 | 6.48 | 6.6 | 95.24 | −1.56 | 4.45 | 88.18 | −0.87 | 3.78 |
| Sample 2 | 10.50 | 6.00 | 5.3 | 94.75 | −2.51 | 4.1 | 87.03 | −1.23 | 3.65 |
| Sample 3A | 13.88 | 5.98 | 7.7 | 95.31 | −1.56 | 4.75 | 88.35 | −1.22 | 4.5 |
| Sample 3B | 13.84 | 6.14 | 7.0 | 94.3 | −2.55 | 4.93 | 85.97 | −1.3 | 4.43 |
| Sample 3C | 16.16 | 6.36 | 7.3 | 95.14 | −1.71 | 4.87 | 87.95 | −1.02 | 4.2 |
| Sample 3 | 10.40 | 5.90 | 6.4 | 94.45 | −2.7 | 4.5 | 86.33 | −1.42 | 4.05 |
| Sample 4A | 13.93 | 6.03 | 10.0 | 95.3 | −2.69 | 6.95 | 88.34 | −2.35 | 6.7 |
| Sample 4B | 13.74 | 6.04 | 9.5 | 94.36 | −3.72 | 7.15 | 86.11 | −2.47 | 6.65 |
| Sample 4C | 16.26 | 6.46 | 9.7 | 95.26 | −2.96 | 7.31 | 88.23 | −2.27 | 6.64 |
| Sample 4 | 10.50 | 6.00 | 9.0 | 94.63 | −3.84 | 6.85 | 86.74 | −2.56 | 6.4 |

The YI, L*, a*, b* and % T values were not corrected for color. For samples having the same number (i.e., Sample 1, Sample 1A, Sample 1B, and Sample 1C), the PVB is the same but the glass type and/or thickness varies. The PVB a* and PVB b* are corrected for glass color and represent the calculated values for the PVB sheet. For Samples 1, 2, 3 and 4, standard clear float glass having a thickness of 2.2 mm was used. For the “A” samples, 4 mm low iron glass was used. For the “B” samples, 4 mm standard clear float glass was used. For the “C” samples, 5 mm low iron glass was used.

As shown by the data in Table 1, the PVB has a* values of −0.86 to −2.56 and b* values of 2.89 to 6.65, showing that the color is very yellow on the L*a*b* color scale. The corrected YI values also show that the PVB has a yellow color (or high yellowness index), ranging from YI of 4.3 to 10.0.

Table 2 shows the properties of standard, commercially available PVB using 1 layer of PVB in combination with different types of glass and different glass thicknesses (glass types and thicknesses are the same as listed above for Table 1).

TABLE 2
standard PVB laminates of a single layer of PVB
(having a nominal thickness of 0.76 mm)

| | L* | a* | b* | % T | PVB a* | PVB b* |
|---|---|---|---|---|---|---|
| Sample 1A mono | 96.3 | −0.49 | 0.63 | 90.73 | −0.15 | 0.38 |
| Sample 1B mono | 95.41 | −1.48 | 0.82 | 88.59 | −0.23 | 0.32 |
| Sample 1C mono | 96.18 | −0.59 | 0.6 | 90.45 | 0.1 | −0.07 |
| Sample 2A mono | 96.25 | −0.5 | 0.72 | 90.6 | −0.16 | 0.47 |
| Sample 2B mono | 95.15 | −1.49 | 0.94 | 87.97 | −0.24 | 0.44 |
| Sample 2C mono | 96.2 | −0.61 | 0.7 | 90.48 | 0.08 | 0.03 |
| Sample 3A mono | 96.27 | −0.55 | 0.82 | 90.65 | −0.21 | 0.57 |
| Sample 3B mono | 95.15 | −1.49 | 1.0 | 87.97 | −0.24 | 0.5 |
| Sample 3C mono | 96.26 | −0.64 | 0.79 | 90.64 | 0.05 | 0.12 |
| Sample 4A mono | 96.23 | −0.9 | 1.53 | 90.56 | −0.56 | 1.28 |
| Sample 4B mono | 95.08 | −1.89 | 1.62 | 87.82 | −0.64 | 1.12 |
| Sample 4C mono | 96.22 | −1.01 | 1.54 | 90.55 | −0.32 | 0.87 |

Since the samples were only a single layer of PVB, YI was not measured. The PVB a* and b* values follow the same trend as for the ten layer samples of Table 1 and are more yellow on the L*a*b* color scale.

Samples of the disclosed, reduced color (lower yellowness) interlayers were produced as described above except that additional colorants were added in amounts sufficient to reduce the yellow color, as previously described. Table 3 shows the properties of the reduced color interlayers when 10 layers are stacked and pressed in the same manner as described for the standard interlayer in Table 1 above.

TABLE 3
Reduced color PVB (pressed stacks of 10 layers haying a
nominal thickness of 6.3 mm) in 4 mm low iron glass

| | PVB | YI | | | | PVB | PVB | |
|---|---|---|---|---|---|---|---|---|
| Sample No. | Thickness | corrected | L* | a* | b* | a* | b* | % T |
| Sample 5 | 5.85 | 0.5 | 91.46 | −1.55 | 0.92 | −0.35 | 0.69 | — |
| Sample 6 | 6.02 | 0.5 | 91.32 | −1.58 | 0.92 | −0.38 | 0.69 | 79.28 |
| Sample 7 | 6.02 | 0.5 | 91.47 | −1.59 | 0.88 | −0.39 | 0.65 | — |
| Sample 8 | 6.01 | 0.6 | 91.34 | −1.64 | 1.0 | −0.44 | 0.77 | 79.25 |
| Sample 9 | 5.98 | 0.6 | 91.41 | −1.6 | 0.96 | −0.4 | 0.73 | — |
| Sample 10 | 5.99 | 0.5 | 91.39 | −1.58 | 0.93 | −0.38 | 0.7 | 79.33 |
| Sample 11 | 5.99 | 0.5 | 91.35 | −1.61 | 0.96 | −0.41 | 0.73 | — |
| Sample 12 | 6.01 | 0.7 | 91.36 | −1.63 | 1.06 | −0.43 | 0.83 | — |
| Sample 13 | 5.91 | 0.7 | 91.42 | −1.65 | 1.07 | −0.45 | 0.84 | 79.42 |
| Sample 14 | 5.98 | 0.7 | 91.38 | −1.64 | 1.1 | −0.44 | 0.87 | — |
| Sample 15 | 6.00 | −0.2 | 90.46 | −1.52 | 0.59 | −0.32 | 0.36 | — |
| Sample 16 | 5.98 | −0.2 | 90.50 | −1.51 | 0.60 | −0.31 | 0.37 | 77.34 |
| Sample 17 | 5.98 | −0.2 | 90.46 | −1.5 | 0.59 | −0.30 | 0.36 | — |

As shown in Table 3, the PVB a* and b* values are significantly lower than the values shown in Table 1 for the same thickness commercially available PVB. The reduced color PVB has lower % T values, but the levels are still within acceptable ranges. The YI values are also significantly lower for the reduced color PVB than those of the standard PVB.

Table 4 shows the properties of the reduced color PVB using 5 layers stacked and pressed together in the same manner as previously described.

TABLE 4
Reduced color PVB (pressed stacks of 5 layers haying a
nominal thickness of 3.8 mm in 4 mm low iron glass

| | PVB | | | | | | |
|---|---|---|---|---|---|---|---|
| Sample No. | Thickness | % T | L* | a* | b* | PVB a* | PVB b* |
| Sample 18 | 3.85 | 82.66 | 92.87 | −1.5 | 0.66 | −0.3 | 0.43 |
| Sample 19 | 3.87 | 82.93 | 92.98 | −1.54 | 0.71 | −0.34 | 0.48 |
| Sample 20 | 3.87 | 83.29 | 93.14 | −1.51 | 0.65 | −0.31 | 0.42 |
| Sample 21 | 3.8 | — | 93.03 | −1.51 | 0.75 | −0.31 | 0.52 |
| Sample 22 | 3.78 | 82.99 | 93.01 | −1.53 | 0.77 | −0.33 | 0.54 |
| Sample 23 | 3.77 | — | 93.04 | −1.54 | 0.76 | −0.34 | 0.53 |

As shown in Table 4, the PVB a* and b* values are very similar to the values shown in Table 3. The reduced color PVB has lower % T values than the standard PVB, but the levels are still within acceptable ranges.

Table 5 shows the properties of one layer of the reduced color PVB laminated as previously described.

TABLE 5
Single layer of reduced color PVB (haying a
nominal thickness of 0.76 mm) in 4 mm low iron glass

| | PVB | | | | | | | | |
|---|---|---|---|---|---|---|---|---|---|
| Sample No. | Thickness | % Tuv | % haze | % T | L* | a* | b* | PVB a* | PVB b* |
| Sample 24 | 0.76 | 13.1 | 0.0 | 88.07 | 95.19 | −1.3 | 0.3 | −0.1 | 0.07 |
| Sample 25 | 0.81 | | | | 95.16 | −1.32 | 0.3 | −0.12 | 0.07 |
| Sample 26 | 0.77 | | | | 95.18 | −1.3 | 0.33 | −0.1 | 0.1 |
| Sample 27 | 0.75 | | | | 95.2 | −1.31 | 0.33 | −0.11 | 0.1 |
| Sample 28 | 0.75 | 12 | 0.0 | 88.12 | 95.21 | −1.28 | 0.32 | −0.08 | 0.09 |
| Sample 29 | 0.76 | | | | 95.2 | −1.3 | 0.35 | −0.1 | 0.12 |

As shown in Table 5, the PVB a* and b* values are significantly lower (and therefore less yellow color) than the values shown in Table 2 for the same thickness (nominal 0.76 mm) commercially available PVB. The reduced color PVB has lower % T values, but the levels are still within acceptable ranges.

The color data (L*a*b*) in Tables 1 to 5 show that addition of a combination of colorants provides a polymer interlayer having reduced or low color (or that is extra clear and has lower yellowness or yellow color). This interlayer having reduced color has a significantly different and improved appearance than the standard, commercially available interlayer. Compare, for example, the data for 10 layers of standard interlayer where the YI is at least 4.3 (Sample 1 in Table 1) and up to YI of 10, while for the reduced color interlayers, all the YI values are less than 1.0, with the highest YI value of 0.7. Similarly, a* and b* values are significantly lower on the reduced color interlayer than on the standard interlayers, showing that the reduced color interlayers are less yellow or have lower yellowness or yellow color.

In conclusion, the polymer interlayers having low color (i.e., extra clear) as described herein have advantages over polymer interlayers that have higher levels of color as they can be more aesthetically pleasing. Other advantages will be readily apparent to those skilled in the art.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

It will further be understood that any of the ranges, values, or characteristics given for any single component of the present disclosure can be used interchangeably with any ranges, values or characteristics given for any of the other components of the disclosure, where compatible, to form an embodiment having defined values for each of the components, as given herein throughout. For example, an interlayer can be formed comprising poly(vinyl butyral) having a residual hydroxyl content in any of the ranges given in addition to comprising a plasticizer in any of the ranges given to form many permutations that are within the scope of the present disclosure, but that would be cumbersome to list. Further, ranges provided for a genus or a category, such as phthalates or benzoates, can also be applied to species within the genus or members of the category, such as dioctyl terephthalate, unless otherwise noted.

1. A poly(vinyl butyral) interlayer comprising:
poly(vinyl butyral) resin and at least one plasticizer,
wherein the interlayer has color coordinates a* and b*, when measured on an interlayer having a thickness of 6.3 mm (as measured according to ASTM E1348 III. D65/10° Obs. CIELab), of −1<a*<0 and 0<b*<2.

2. The poly(vinyl butyral) interlayer of claim 1, wherein the interlayer has color coordinates a* and b*, when measured on an interlayer having a thickness of 6.3 mm (as measured according to ASTM E1348 III. D65/10° Obs. CIELab), of −0.55<a*<0 and 0<b*<1.2.

3. The poly(vinyl butyral) interlayer of claim 1, wherein the interlayer has color coordinates a* and b*, when measured on an interlayer having a thickness of 6.3 mm (as measured according to ASTM E1348 III. D65/10° Obs. CIELab), of −0.3<a*<0 and 0<b*<0.4.

4. The poly(vinyl butyral) interlayer of claim 1, wherein the interlayer has a yellowness index (YI) of from about −1.0 to 1.0 when measured on an interlayer having a thickness of 6.3 mm (as measured according to ASTM E313 III C/2° obs).

5. The poly(vinyl butyral) interlayer of claim 1, wherein the interlayer has a yellowness index (YI) of from about −1.0 to 1.0 when measured on an interlayer having a thickness of 3.8 mm (as measured according to ASTM E313 III C/2° obs).

6. The poly(vinyl butyral) interlayer of claim 1, wherein L*≥90 when measured on a laminate having an interlayer with a thickness of 6.3 mm (as measured according to ASTM E1348 III. D65/10° Obs. CIELab).

7. The poly(vinyl butyral) interlayer of claim 1, wherein L*≥92 when measured on a laminate having an interlayer with a thickness of 3.8 mm (as measured according to ASTM E1348 III. D65/10° Obs. CIELab).

8. The poly(vinyl butyral) interlayer of claim 1, wherein L*≥95 when measured on a laminate having an interlayer with a thickness of 0.76 mm (as measured according to ASTM E1348 III. D65/10° Obs. CIELab).

9. The poly(vinyl butyral) interlayer of claim 1, wherein the interlayer is a multilayer interlayer having at least two layers.

10. The poly(vinyl butyral) interlayer of claim 1, wherein the interlayer is a multilayer interlayer having at least three layers.

11. A transparent multiple layer panel comprising:
a first glass substrate, and
a second glass substrate,
wherein the first and second glass substrates consist of extra clear float glass having a thickness of 4 mm and color coordinates L*, a* and b* wherein L*=96.6, −0.20<a*<0.15 and 0.08<b*<0.15,
and the poly(vinyl butyral) interlayer of claim 1 between the first and second substrates,
wherein the multiple layer panel has color coordinates L*, a* and b*, wherein L*=92, a*=−0.7 and b*=0.7 (when measured according to ASTM E1348 III. D65/10° Obs. CIELab).

12. The multiple layer panel of claim 11, wherein the multiple layer panel has a Luminous Transmittance (% T) of at least 80% (when measured according to ASTM D1003 and ASTM E1348 III. D65/10° Obs. CIELab).

13. The multilayer panel of claim 11, wherein the interlayer is a multilayer interlayer having at least one layer of 0.76 mm thickness.

14. The multilayer panel of claim 11, wherein the interlayer is a multilayer interlayer having at least two layers of 0.76 mm thickness.

15. A transparent multiple layer panel comprising:
a first rigid substrate comprising float glass having a nominal thickness of 6 mm having color coordinates L*, a* and b*, wherein L*=97.7, a*=−0.05, b*=0.7,
a second rigid substrate comprising float glass having a nominal thickness of 6 mm having color coordinates L*, a* and b*, wherein L*=97.7, a*=−0.05, b*=0.7,
and a poly(vinyl butyral) interlayer having a nominal thickness of 0.76 mm between the first and second substrates,
wherein the multiple layer panel has color coordinates L*, a* and b*, wherein L*≥97.5, 0<a*<−0.4 and 0<b*<1.5,
and wherein the interlayer has color coordinates a* and b* of 0<a*<0.48 and 0<b*<0.6 when measured according to ASTM E1348 III. D65/10° Obs. CIELab.

16. A transparent multiple layer panel comprising:
a first rigid substrate comprising float glass having a nominal thickness of 6 mm having color coordinates L*, a* and b*, wherein L*=97.7, a*=−0.05, b*=0.7,
a second rigid substrate comprising float glass having a nominal thickness of 6 mm having color coordinates L*, a* and b*, wherein L*=97.7, a*=−0.05, b*=0.7,
and a poly(vinyl butyral) interlayer having a nominal thickness of 1.52 mm between the first and second substrates,
wherein the multiple layer panel has color coordinates L*, a* and b*, wherein L*≥97.5, 0<a*<−0.48 and 0<b*<1.5,
and wherein the interlayer has color coordinates a* and b* of 0<a*<0.25 and 0<b*<0.35 when measured according to ASTM E1348 III. D65/10° Obs. CIELab.
